(19) United States
(12) Patent Application Publication
(10) Pub. No.: US 2008/0034017 A1
(43) Pub. Date: Feb. 7, 2008

(54) Links to a common item in a data structure

(76) Inventors: Dominic Giampaolo, Mountain View, CA (US); Don Brady, Woodland Park, CO (US); Pavel Cisler, Los Gatos, CA (US)

Correspondence Address: FISH & RICHARDSON P.C., PO BOX 1022, MINNEAPOLIS, MN, 55440-1022, US

(21) Appl. No.: 11/499,386

(22) Filed: Aug. 4, 2006

(51) Int. Cl. G06F 17/30

(52) U.S. Cl. 707/204

(57) ABSTRACT

Systems and methods are provided for linking data. In one implementation a method is provided. A first backup is generated. The first backup includes a first hierarchical file system, where entries in the first hierarchal file system reference corresponding source data of the first backup. A second backup is generated. The second backup includes a second hierarchical file system, where the second hierarchical file system includes one or more links referencing source data of the first backup.

### RELATED APPLICATIONS

This application is generally related to the following jointly owned and co-pending patent applications, each incorporated herein by reference in its entirety:

U.S. Patent Application No. ______, for “Managing Backup of Content,” filed Aug. 4, 2006;

U.S. Patent Application No. ______, for “User Interface for Backup Management,” filed Aug. 4, 2006;

U.S. Patent Application No. ______, for “Navigation of Electronic Backups,” filed Aug. 4, 2006;

U.S. Patent Application No. ______, for “Architecture for Back Up and/or Recovery of Electronic Data,” filed Aug. 4, 2006;

U.S. Patent Application No. ______, for “Searching a Backup Archive,” filed Aug. 4, 2006;

U.S. Patent Application No. ______, for “Conflict Resolution in Recovery of Electronic Data,” filed Aug. 4, 2006;

U.S. Patent Application No. ______, for “System for Multi-Device Electronic Backup,” filed Aug. 4, 2006;

U.S. Patent Application No. ______, for “System for Electronic Backup,” filed Aug. 4, 2006;

U.S. Patent Application No. ______, for “Restoring Electronic Information,” filed Aug. 4, 2006;

U.S. Patent Application No. ______, for “Application-Based Backup-Restore of Electronic Information,” filed Aug. 4, 2006;

U.S. Patent Application No. ______, for “Event Notification Management,” filed Aug. 4, 2006;

U.S. Patent Application No. ______, for “Consistent Back Up of Electronic Information,” filed Aug. 4, 2006.

### TECHNICAL FIELD

The disclosed implementations relate generally storing and restoring data.

### BACKGROUND

A hallmark of modern graphical user interfaces is that they allow a large number of graphical objects or items to be displayed on a display screen at the same time. Leading personal computer operating systems, such as Apple Mac. OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

With the sophisticated tools available, users are encouraged not only to create and save a multitude of items in their computers, but to revise or otherwise improve on them over time. For example, a user can work with a certain file and thereafter save its current version on a storage device. The next day, however, the user could have had second thoughts about the revisions, or could have come up with new ideas, and therefore opens the file again.

The revision process is usually straightforward if the user wants to add more material to the file or make changes to what is there. But it is typically more difficult for a user who has changed his/her mind about changes that were previously made and wants the file back as it was once before. Application programs for word processing typically let the user “undo” previous edits of a text, at least up to a predefined number of past revisions. The undo feature also usually is configured so that the previously made revisions must be undone in reverse chronological order; that is, the user must first undo the most recently made edit, then the second-most recent one, and so on. If the user saves and closes the document and thereafter opens it again, it may not be possible to automatically undo any previous edits.

### SUMMARY

Systems and methods are provided for linking data. In one implementation, links are generated which point to folders instead of only files. The links can be used to minimize storage of backup data. Incremental backups which have a hierarchal data structure can include links to earlier data. For example, a folder that is unchanged in an incremental backup from an earlier backup can be stored in the incremental backup as a link to the earlier backup of the folder instead of storing the current folder and all its contents.

In general, in one aspect, a method is provided. A first backup is generated. The first backup includes a first hierarchical file system, where entries in the first hierarchal file system reference corresponding source data of the first backup. A second backup is generated. The second backup includes a second hierarchical file system, where the second hierarchical file system includes one or more links referencing source data of the first backup.

Implementations of the method can include one or more of the following features. The one or more links can include a link from a folder in the second hierarchical file system to data associated with the folder in the source data of the first backup. The one or more links can be hard links. The first backup can be generated prior to the second backup. The method can further include preventing the addition of new links to the first hierarchical file system after it has been created. The preventing can include flagging the first hierarchical file system as not accepting any new links.

Generating the second backup can include generating the second hierarchical file system. Generating the second hierarchical file system can include determining whether particular source data from the second backup is unchanged from source data of the first backup and for the unchanged source data, generating one or more links in the second hierarchical file system referencing the unchanged source data in the first backup. The first hierarchical file system can have a structure that includes a plurality of entries, each entry including one or more additional entries. One or more of the entries can be files.

In general, in one aspect, a method is provided. A search for an item is received. The search includes one or more parameters. A matching entry in the file system is identified. If the matching entry is a link, a chain of sibling links including the matching entry are identified and the entries associated with the sibling links are presented.

Implementations of the method can include one or more of the following features. Receiving a search for an item can further include designating one or more search parameters associated with the search for an item and presenting only the entries matching the designated search parameters. One of the one or more search parameters can be a time range associated with the search item. The method can further include determining if the matching entry is a link. The determining can include searching for the matching entry in a file system catalog and identifying whether the matching entry is part of a chain of sibling entries.

In general, in one aspect, a method is provided. A second file system entry in a file system hierarchy is generated. The second file system entry has a reference to source data already referenced by a first file system entry. The second file system entry is associated with the first file system entry to form a sibling chain of links.

Implementations of the method can include one or more of the following features. The method can further include receiving subsequent file system entries, each file system entry referencing source data referenced by the first file system entry and adding each subsequent file system entry to the sibling chain of links. The method can further include receiving a search for an item associated with a link, identifying each link in the sibling chain of links, and determining one or more matching entries associated with the links of the sibling chain of links to present to a user. The determining can include comparing the matching entries with one or more parameters associated with the received search.

In general, in one aspect, a method is provided. A first backup is generated. The first backup includes a first hierarchical file system, where entries in the first hierarchical file system reference corresponding source data of the first backup. A second backup is generated. The second backup includes a second hierarchical file system, where the second hierarchical file system includes one or more link entries referencing source data of the first backup. A search query associated with particular source data is received. A search is performed for entries in the first and second backups referencing the source data associated with the search query. Search results are presented including an entry from the first file hierarchical system and at least one link entry from the second hierarchical file system.

In general, in one aspect, a data structure is provided. The data structure includes a hierarchical file system having a plurality of entries. The entries have a reference to particular source data. An entry in the plurality of entries is a first folder entry. The first folder entry has a one or more child entries. An entry is a second folder entry. The second folder entry being a link referencing identical source data referenced by the first folder entry.

In general, in one aspect, a method is provided. A backup operation is initiated. Data is identified to be included in the backup. A previous backup is located. Data of the previous backup is compared with the data to be included in the backup to identify new data to be stored and old data that is unchanged from the previous backup. The new data and a plurality of links to the old data are stored.

Implementations can include one or more of the following features. The previous backup can be an immediately preceding backup. Comparing data can include identifying data present in the data to be included in the backup that is not present in the data of the previous backup.

Particular embodiments of the subject matter described in this specification can be implemented to realize one or more of the following advantages. A backup can be generated having links to a previous backup. The links can be used to reference portions of a file system such as folders or entire directories. The links can be used to generate backups efficiently and using less storages space than a full copy of the backup data.

The details of the various aspects of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example of an architecture for managing multiple links directed to a common item.

FIG. 2 is a block diagram of an example of a folder structure including two item entries that link to the same item data.

FIG. 3 is a block diagram of an example of an item entry.

FIG. 4 is a block diagram of an example of an architecture for backing up and restoring application files.

FIG. 5 shows an example of a time machine user interface.

FIG. 6 is a block diagram of an example of items in two snapshots that link to the same or different item data.

FIG. 7 is a flow chart of an example of a process for associating links with a chain of links.

FIG. 8 is a flow chart of an example of a process for using a chain of links in performing a search.

### DETAILED DESCRIPTION

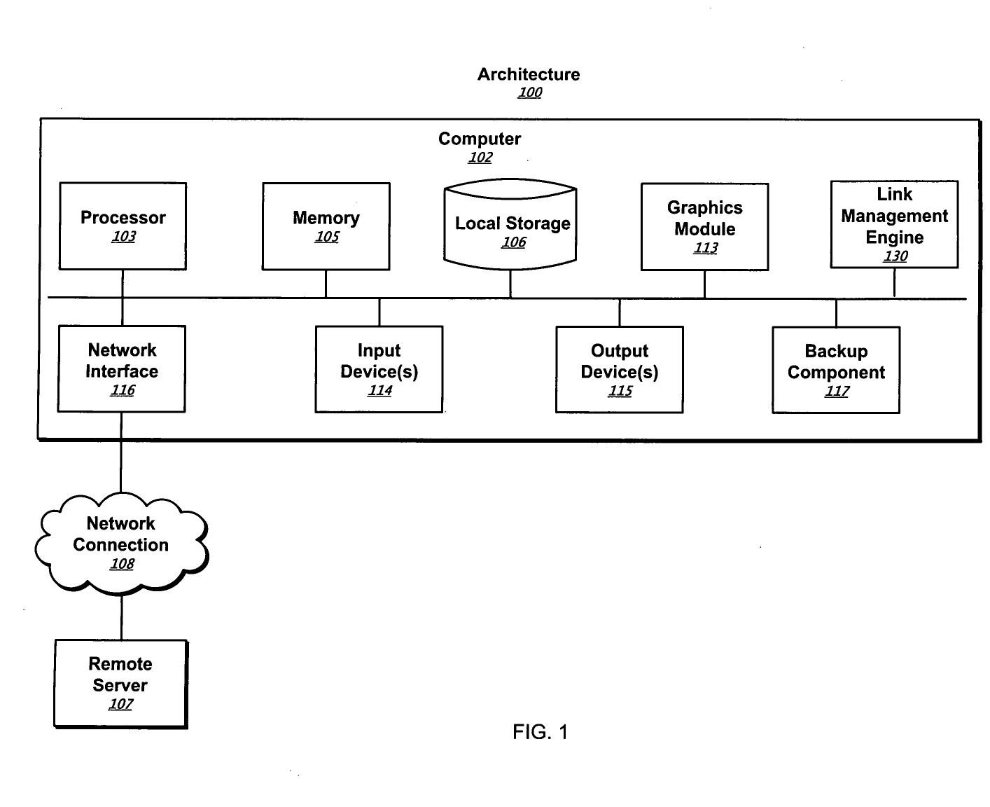

FIG. 1 is a block diagram of an architecture 100 for managing one or more links directed to an item in a storage system. As used herein, a link refers to an information portion, manageable by a link management engine (e.g., link management engine 130 described below), that relates to an item in the storage system. Each item can be of the form of a file, folder, image, content, setting, value, status information, or data, to name a few examples. Multiple links can be generated at different times or by different portions of the architecture to identify a common item, and each of the links can be used to access the identified item. For example, when the link identifies a particular source file, the link can appear indistinguishable to a user from the source file itself. As such, the presence or absence of the link can be transparent to the user. That is, in some implementations, it is not readily apparent to the user whether a file entry is a direct representation of the source file or whether it represents a linking to the source file that is automatically performed when the file entry is activated. In one implementation, one or more of the links are hard links.

The architecture 100 includes a personal computer 102 communicatively coupled to a remote server 107 via a network interface 116 and a network 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While link management is described herein with respect to a personal computer 102, it should be apparent that the disclosed implementations can be incorporated in, or integrated with, any electronic device, including without limitation, portable and desktop computers, servers, electronics, media players, game devices, mobile phones, email devices, personal digital assistants (PDAs), embedded devices, televisions, other consumer electronic devices, etc.

Systems and methods are provided for managing links to a common item or content. The systems and methods can be stand-alone, or otherwise integrated into a more comprehensive application. In the materials presented below, an integrated system and method for link management is disclosed.

One of ordinary skill in the art will recognize that the engines, methods, processes and the like that are described can themselves be an individual process or application, part of an operating system, a plug-in, an application, or the like. In one implementation, the system and methods can be implemented as one or more plug-ins that are installed and run on the personal computer 102. The plug-ins are configured to interact with an operating system (e.g., MAC OS® X, WINDOWS XP, LINUX, etc.) and to perform the various functions, as described with respect to the Figures. A system and method for link management can also be implemented as one or more software applications running on the computer 102. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 102 includes a backup component 117 that allows for the storage of versions of the computer's files or other items (e.g., restoring a view including past state of a file, application, application data, parameters, settings, and the like), for example within the local storage 106 or in an external storage repository. For example, the backup component 117 can capture at least one earlier version of a user interface view and allow a user to initiate a restoration based on it. In order to minimize storage space, links can be used when creating the versions as will be discussed in greater detail below. As used herein, a view refers to an item, or other content, capable of being presented in a user interface, that can be subjected to a backup operation by the backup component 117. For example, a user interface view can contain any number of icons, files, folders, application state information, and/or machine state information, etc. In one implementation, the backup component 117 also allows a user to select any of the stored versions and use it to initiate a restoration of that version in the computer.

Though discussion is made with reference to a user interface view, those of ordinary skill will recognize that such a view can be based on various data structures, files, processes, and other aspects of information management. It follows that modification to file structures, data and the like is also contemplated in order to achieve the modification to the user interface view. In other words, while the restoration of the user interface view from one state to another can be the most apparent change from the user's perspective, this is accomplished through the corresponding changes in the underlying system content.

A link management engine (e.g., link management engine 130 discussed below) can be used to coordinate links to items, such as between two or more captured versions of user interface views. For example, if a particular item, such as a file, folder, icon, or application/machine state information, has not changed from one captured user interface view version to another, the link management engine 130 can create and manage a link from an entry representing the latest captured item version to the item in the previously captured item version. A user of the system 100 can access the item either through the previously captured item version or by using the link in the latest captured version. This allows the system 100 to store one copy of each unique instance of an item versus storing a separate identical copy of an item for every captured version of a user interface view. In one implementation, it can be transparent to the user that the access through the previously captured item version is direct and the access through the latest captured item version is through the link. Other link arrangements may be managed and used in the system 100.

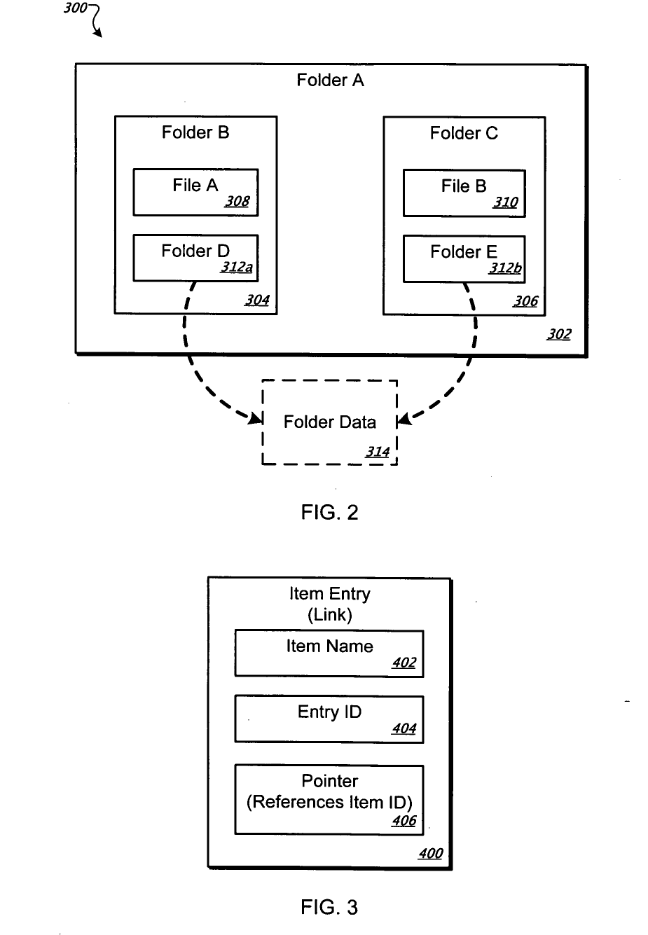

FIG. 2 is a block diagram of an example of a folder structure 300 including two item entries that link to the same item data. The folder structure 300 contains a folder 302 (“Folder A”) that in turn includes a folder 304 (“Folder B”) and a folder 306 (“Folder C”). Folder B and Folder C in turn include items, such as a file 308 (“File A”) and a file 310 (“File B”), respectively. Folder B and Folder C also include sub-folders 312a (“Folder D”) and 312b (“Folder E”), respectively. Here, Folder D and Folder E have the same content. That is, each of these item entries provides access to the same item data, a folder data item 314. Thus, the user sees the identical data in the Folder D as in the Folder E. In other words, a user can access the folder data 314 from either Folder D or Folder E. In one implementation, the folder D represents a previously performed capture of the folder data 314, and the Folder E links to the folder data 314 in, representing a more recently performed capture, where there was no change in the folder data between the captures.

FIG. 3 is a block diagram of an example of an item entry 400. The item entry 400 can be placed in a hierarchy structure accessible to a user, optionally together with other entries, where it can be used to access a particular item. Here, the item entry 400 represents a particular item with a unique item ID. For example, the item can be a file or a folder and the item entry is an icon in the hierarchy that represents the file or the folder. In this example, the item entry 400 is consistent with those of the hierarchical file system used in products from Apple Computer in Cupertino, Calif. Other types of item entries compatible with the links described herein can be used.

The item entry includes an item name 402, an entry ID 404, and a pointer 406. The item name 402 is the name of the item entry 400 and can be presented in a user interface. For example, the “Folder D” name can be assigned using the item name 402. The entry ID 404 uniquely identifies the item entry 400. This means that two item entries that are assigned to a common folder or location can have the same item name 402. The pointer 406 references the item ID of the item that the item entry 400 represents. For example, the pointer 406 can reference an identifier that uniquely identifies a particular file. The item ID can be used to locate the item data to which the item entry links. Particularly, when the item entry 400 is activated, the system can automatically access the item and display its contents. Thus, a user can access the item using the item entry. As noted above, two or more of the item entries 400 referring to the same item ID can be created in a system. For example, when the item is subject to backup operations, a first one of such entries can represent a previous backup and a second one can represent a more recent backup.

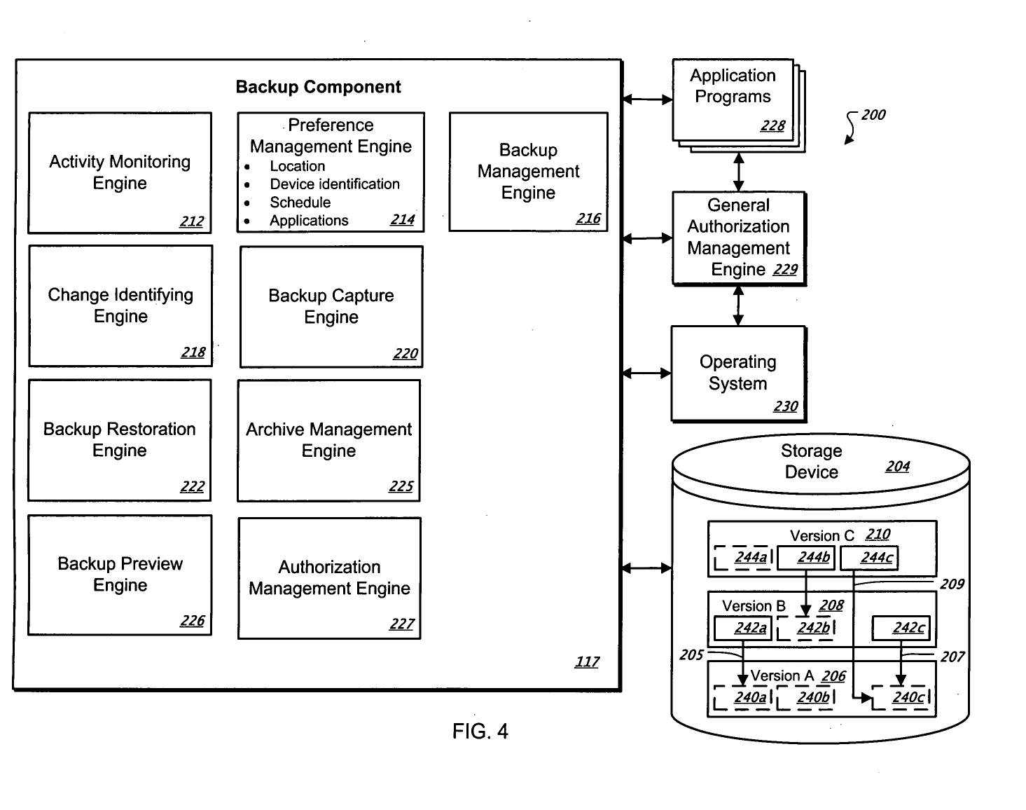

FIG. 4 is a block diagram of an exemplary architecture 200 for enabling the backup and restoration of data (e.g., application files, application data, settings, parameters or the like), such as those associated with a set of application programs 228. Backup component 117 provides backup and restoration capability for the system. Many different items can be the subject of backup in the system. For example, folders, files, items, information portions, directories, images, system or application parameters, playlists, e-mail, inbox, application data, address book, preferences, and the like all can be candidates for archiving. Other types are also possible. In this example, the backup component 117 uses a storage device 204. This can be an internal or external resource, or a combination of the two. Any number of local and/or external storage devices can be used by the backup component 117 for storing versions. In this implementation, the backup component 117 views any and all storage device(s) designated for version storage as a single memory bank.

In one implementation, the backup component runs as a background task on an operating system 230 that is not visible to the user. The backup component can be capable of running across multiple user accounts.

The backup component 117 includes an activity monitoring engine 212. In one implementation, the activity monitoring engine 212 monitors for changes within an application view (e.g. files) that are targeted for backup operations. A change can also include the addition of new files or data or the deletion of the same. In one implementation, the activity monitoring engine 212 is capable of discerning between a substantive change (e.g. the text within a document has been modified) and a non-substantive change (e.g. the play count within an iTunes playlist has been updated, or several changes cancel each other out) through its interaction with the application programs 228. The activity monitoring engine 212 can, for example, create a list of modified items to be used when a backup event is eventually triggered. In one implementation, the activity monitoring engine 212 can monitor the system for periods of inactivity. The activity monitoring engine 212 can then trigger a backup event during a period of time in which the backup operation will not cause a system slowdown for an active user.

A preference management engine 214 specifies some operating parameters of the backup component 117. In one implementation, preference management engine 214 contains user-specified and/or system default application parameters for the backup component 117. These can include settings for the details of capturing and storing the earlier versions. For example, the preference management engine 214 can determine the frequency of a backup capture, the storage location for the backup versions, the types of files, data, or other items that are eligible for backup capture, and the events which trigger a backup capture (periodic or event-driven, etc.). Particularly, the preference management engine 214 can specify that links are to be used in the captured backup versions when appropriate. This can trigger the link management engine 130 to determine whether a currently made backup contains content that is identical to a previous backup. If so, the link management engine 130 can create a link in the new backup to content in the previous backup.

In one implementation, the preference management engine 214 can detect that a new storage device is being added to the system and prompt the user whether it should be included as a backup repository. Files and other items can be scheduled for a backup operation due to location (e.g. everything on the C: drive and within D:/photos), a correlation with specific applications (e.g. all pictures, music, e-mail, address book and system settings), or a combination of strategies. Different types of items can be scheduled to be stored on different devices or on different segments of a storage device during a backup operation. In one implementation, the backup component 117 stores the versions in a format corresponding to a file system structure.

A backup management engine 216 coordinates the collection, storage, and retrieval of view versions performed by the backup component 117. For example, the backup management engine 216 can trigger the activity monitoring engine 212 to watch for activities that satisfy a requirement specified in the preference management engine 214.

A change identifying engine 218 locates specific views or other items within to determine if they have changed. The change identifying engine 218 may be capable of discerning a substantive change from a non-substantive change, similar to the example described above for the activity monitoring engine 212. In one implementation, the change identifying engine 218 traverses a target set of files, data, or other items, comparing a previous version to the current version to determine whether or not a modification has occurred. For example, the link management engine 130 can prompt the change identifying engine 218 to determine whether a currently made backup contains content that is identical to a previous backup. The link management engine 130 can use the outcome of this determination to decide whether to create a link from the current backup to the previous backup.

A backup capture engine 220 locates files, data, or other items that are to be backed up. The backup capture engine 220 could invoke the activity monitoring engine 212 and/or the change identifying engine 218, for example, to generate a capture list. The backup capture engine 220 can then store copies of these items in one or more targeted storage repositories. The backup capture engine 220 can track multiple version copies of each item included in the backup repository.

The backup component 117 includes a backup restoration engine 222 to restore previous views (e.g. versions of files, data, or other items). In one implementation, the backup restoration engine 222 provides a user interface (e.g., a graphical user interface) where a user can select the item(s) to be restored.

The backup component 117 can manage multiple versions of an item using links, for example in form of entry items. There will now be described an example of how the link management engine 130 coordinates the item links between versions. Within the storage device 204 a first backup archive 206 (“Version A”) is a backup version of an item. Version A contains three separate archived items 240a-c. The Version A corresponds to the contents of the item at a particular point in time. After version A is captured, a user in this example changes the item somewhat by creating a new version of the item 240b, for example by editing a document. Later, another capture event creates a second backup archive 208 (“Version B”) of the item (e.g., a capture event recognized by the activity monitoring engine 212 or the change identifying engine 218 results in the generation of a second version by the backup capture engine 220), the Version B including item entries 242a-c. Items 242a and 242c are identical to those in Version A. The link management engine 130 can be used to create a link 205 from the item entry 242a to the item 240a as part of the generation process. Accordingly, only one copy of item 240a is required to be stored within the storage device 204 at the time Version B is created. Similarly, a link 207 connects item entry 242c to the item 240c. The item 242b, in contrast, is not identical to the item 240b and is therefore stored in Version B with its current contents. A user can access any of the items in the Version A, or any of the items listed in the Version B, or all of them. In one implementation, the user may not be able to detect that some items are accessed directly (e.g., the item 242b accessed through Version B), and some are accessed using a link (e.g., the item 240a accessed using item entry 242a in Version B).

At a later time, a user modifies information associated with the item 240a. A third backup archive 210 (“Version C”) can then be generated (by for example, the backup capture engine 220). Version C includes corresponding item entries 244a-c. Here, the item 244a is different from the item 240a and the contents of item 244a are therefore stored in Version C. Accordingly, there is no link equivalent to the link 205 from this item to the item 240a. However, the item 244b has not been changed since Version B and the item 240c has not been changed since Version A. The link management engine 130 can create a link 209 from the item entry 244c to the item 240c as part of the version archive process. Similarly, a link is created from the item entry 244b to the item 242b. In this example, it is seen that the link management engine 130 manages links across multiple version sets. That is, each of Version B and Version C contains one or more links to an earlier version where appropriate. Other configurations of items, item entries and links can be used.

A backup preview engine 226 is configured to provide a preview of at least one of the captured earlier versions. The preview can allow a user to peruse the contents of a backup copy of a view (e.g., a file, data, or file set) before opting to restore the item (e.g. file(s)) using the backup restoration engine 222. The preview can be generated by accessing a backup item directly or, when applicable, through a link.

The archived copies can be compressed and/or encrypted. An example of a compression technique is the ZIP file format for data compression and archiving. An example of an encryption technique is the RSA algorithm for public key encryption. Other compression techniques or encryption techniques can be used. In one implementation, the archive storage structure mimics a typical file system structure, such that the archived versions can be perused using a standard file system viewing utility.

Access to data items within the architecture 200 or the computer system 102 can be controlled by a general authorization management engine 229. The general authorization management engine 229 stores permissions settings for individual data items, such as a file, folder, or disk drive. Before a user gains access to a data item, the item's permissions settings would be verified by the general authorization management engine 229. In one implementation, the general authorization management engine requires a password or other authorization data (e.g. biometric data, etc.) before allowing a user access to a particular data item.

An archive management engine 225 tracks where archived views are being stored. In one implementation, the archive management engine 225 obtains user options from the preference management engine. Such settings can include, but are not limited to, methods to be used to remove older or otherwise unnecessary archived views. These settings can establish one or more criteria for archived view deletion, for instance in the event of storage capacity being reached or on a regular basis. In one implementation, the archive management engine 225 alerts the user when archives are missing because a device has gone offline. In another implementation, the archive management engine 225 can bar a user from viewing another user's archive data due to system permissions settings.

Restrictions can be used when links are created. This can avoid some problems relating to circular referencing when the link is to an entire folder. In one exemplary embodiment, the target data of the link is associated with a hierarchy that is tagged as “no new links”. This refers to the original file structure associated with the data without using links. In other words, when a link to a previous backup is created in a more recent backup, the previous backup is locked so that new links cannot be created in its hierarchy. Additionally, when creating a new link in a hierarchy (e.g., when generating a backup), the parents of the link (e.g., a location higher in the hierarchy from the link) are not tagged as “no new links”. Here, these two restrictions seek to ensure that links only go one-way, backwards in time toward fixed data. Additionally, there can be used a restriction that links cannot be moved or renamed after creation, which can also help prevent circular anomalies.

The backup component 117 can include an authorization management engine 227 that controls users' access to archived states, for example by storing permission settings for individual data items within the data archives. In one implementation, if multiple users make use of the time machine backup component 117 on a single system, each user can choose to keep separate archives. Access to an individual user's archives can be password protected or otherwise held in a secure manner. In one implementation, the data within the user's archives contain the same read/write permissions as the original data item. In one implementation, the authorization management engine 227 inherits the data items' permissions settings from the general authorization management engine 229 and indexes the archived contents accordingly. Using these permissions settings, the authorization management engine 227 can deny a user access to a copy of a data item when the user would not have authorization to view the original data item. In another implementation, the user can establish permissions or encryption techniques specifically for the data archives. User permissions and encryption settings could be user-selectable from within the preference management engine. The preference management engine would then transfer the settings to the authorization management engine for storage.

As a particular example of authorization management, the authorization management engine 227 or the general authorization management engine 229 (or both) can specify that a particular user is not allowed to view all portions of the file system. When this user searches for a specific file, links to that file that exist in both the protected and unprotected portions of the system can be found. If the search finds the link that is located in the unprotected area, this link will appear as a result and the user can access the file with it. If, however, only the link in the protected portion is identified, the user will get no results, due to the access restriction. This situation is one in which it can be helpful to automatically extend the user's search to sibling links, and an example of this will be described later.

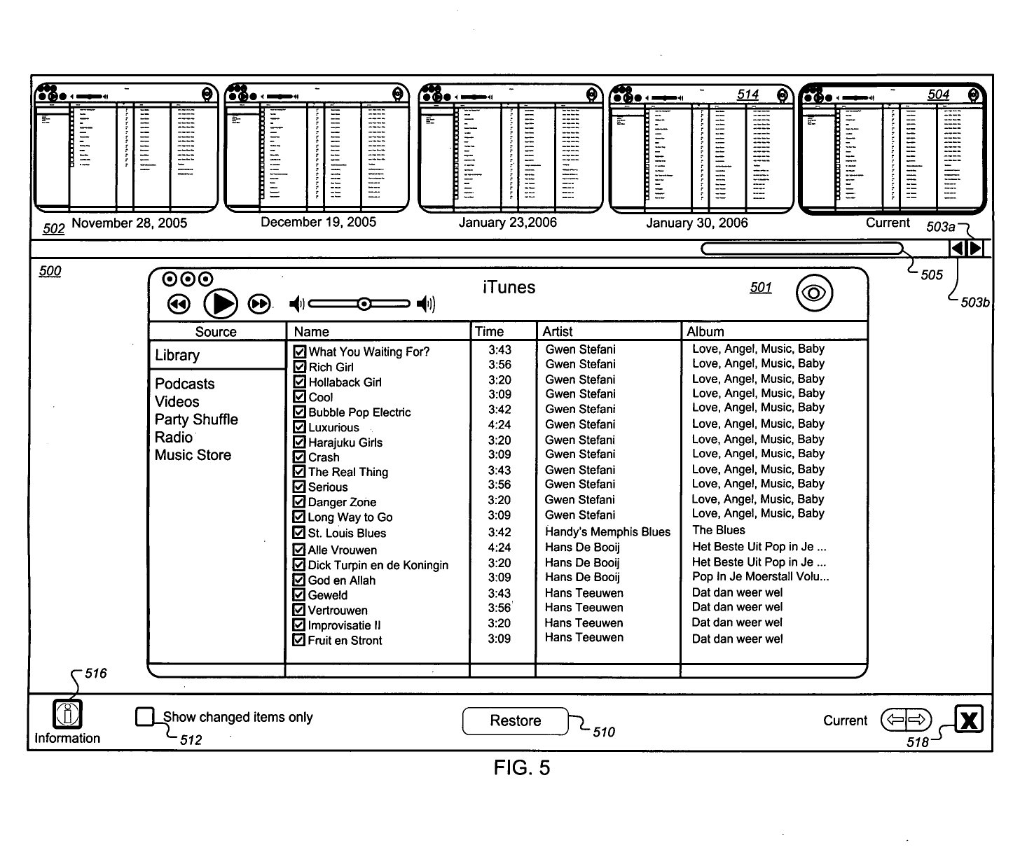

There will now be described an example of a user interface that can be used with backup versions of views (e.g., including files, data, or other items) created by the backup component 117. In one implementation, the user interface is generated by the operating system 230 and the backup component 117. FIG. 5 is a screen shot showing a time machine interface 500. Upon the time machine interface being launched, the user can search for missing data, for example, and optionally restore this data. In some implementations, the user can also restore data content other than the missing data using the time machine interface.

The time machine interface 500 here includes a presentation window 501, a timeline 502, and function buttons. The timeline 502 includes a number of snapshots. As used herein, a snapshot refers to a backup item stored in an archive that includes a backup of selected items or content as specified by the backup component 117. The time machine user interface 500 can also include function buttons. The interface 500 includes arrow buttons 503a and 503b, and an associated scroll bar 505 to allow the user to navigate to additional snapshots not shown in the current timeline window. Thus, there can be a large number of snapshots from which to select.

Here, the user has initiated the time machine interface for a music file management program, namely the iTunes™ application available from Apple Computer. As shown, the presentation window 501 is displaying the current state of the iTunes™ application because a “current” snapshot 504 has been selected (highlighted) in the timeline. The current snapshot can be a default selection. The presentation window 501 can show the contents corresponding to the currently selected snapshot, or a portion thereof.

In this particular example, the timeline contains a date beneath each snapshot indicating when the snapshot was taken. In some implementations, the user can select items or content within the snapshots. The selection functionality can be used in earlier snapshots, such as snapshot 514, to restore missing data to the state associated with the current snapshot 504.

The timeline 502 can include a number of snapshots representing earlier versions or states of the iTunes™ library that have been backed up. Each snapshot provides a screenshot representation of the earlier version of the iTunes™ library at a particular point in time. In some implementations, the timeline 502 includes a visual representation of backup items, such as a miniature version of the earlier state. The timeline can appear across the top portion of the time machine interface 502 (as shown). Alternatively, the timeline does not appear in the top portion of the time machine interface 500 until a user moves their cursor to (or otherwise activates) the timeline (e.g., by activating the top portion of the interface).

The interface can include a restore button 510 that, when selected, restores the view to the selected state represented by the selected snapshot, or to a selected portion thereof, to name two examples. In some implementations, this terminates the session of the time machine. A user can select one item in a snapshot and then select the restore button 510 to modify the current version of the item selected (e.g., restore the state of the view). For example, in iTunes™, the user can select one or more songs to restore, and this can trigger the restore button to display a more precise message, such as “restore selection only.”

As noted above, the backup component 117 can be configured to use links for one or more items in the captured versions, and these links can be created and managed by the link management engine 130. In this example, it can be seen that the list of songs in the current version (corresponding to snapshot 504) is identical to an earlier list, at least the one in the snapshot 514, which was captured on Jan. 30, 2006. When links are used, this means that the item entry corresponding to the playlist in the current version of the iTunes™ application contains a link to the item captured earlier, as opposed to containing all the contents of the current playlist. Thus, when the user accesses any snapshot that includes this identical playlist, the system follows a link to the playlist item. Similarly, each of the listed songs is an item that can be subject to backup procedure. If links are used and a song item is not changed from one backup event to the next, there can be created a link from the item entry in the later backup version(s) to the item itself.

In one implementation, a changed items only checkbox control 512 filters the snapshots to show only those that differ from the current state. In one implementation, the checkbox control 512 does not refer to the incremental changes between snapshots in the timeline 502, but rather when invoked acts to omit those snapshots whose states are identical to the current state of the iTunes™ library from being presented in the timeline. For example, if the most recent snapshot 504 is identical to a snapshot 514 that occurs earlier in time, selecting the changed items only checkbox control 512, in one implementation, causes the time machine to cease displaying one of these versions, e.g., by removing the snapshot 514 from the timeline. This can help the user locate previous versions whose contents are different from those in the current version. Also, a change in an item means that the item entry is not merely a link to the item stored elsewhere. Thus, by keeping only those snapshots that contain changes, it can be ensured that those snapshots contain at least some actual item content, as opposed to links back to the stored item(s). However, as has been mentioned, the links can be implemented so that the user can not distinguish them from actual content.

An information button 516 provides information regarding the selected snapshot. In one implementation, selecting the information button 516 opens a panel display. The panel display can provide information including the date and time the snapshot was made, the location of actual contents in a snapshot, the size of the snapshot, and a comment section, to name a few examples. In some implementations, the information button 516 can provide information about links, where applicable. A close button 518 can be selected to exit the time machine and return the user to the desktop. In some implementations, the time machine engine can automatically close upon a particular snapshot being restored. In some implementations, the user can minimize the time machine for purposes of navigating to other applications, such as an email application or a web browser.

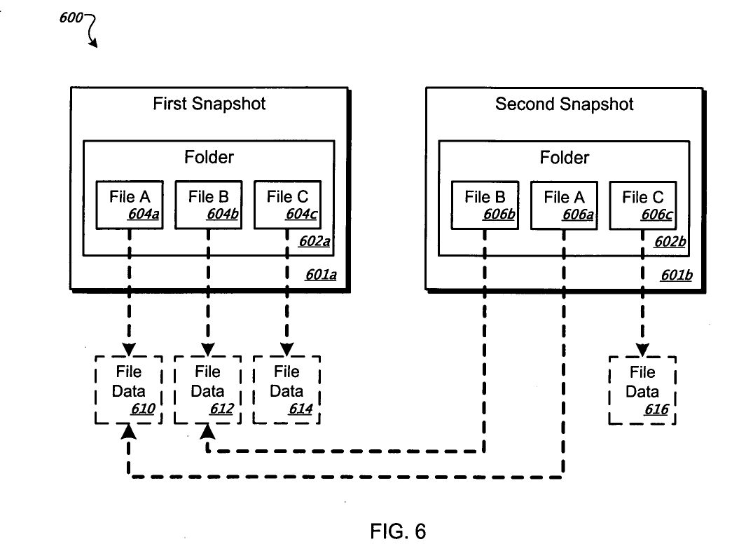

Another example will illustrate the use of links with backup versions captured with the backup component 117. FIG. 6 is a block diagram of an example of an arrangement 600 of items. Here, the arrangement 600 contains two snapshots 601a-b with item entries that link to the same or different item data. The snapshots 601a-b include a first version 602a of a folder, captured at an earlier time, and second version 602b of the folder, captured after the first version. The folder includes three files in each backup. The first folder version 602a includes file entries 604a-c that link to file data 610, 612, and 614, respectively. The second folder version 602b includes file entries 606a-c. In the second snapshot 601b, the files represented by the file entries 606a-b (files 610, 612) have not changed since the first version. Therefore, the link management engine 130 provides the file entries 606a-b with pointers to the file data 610 and 612. The file data 614 is no longer part of the folder when the second backup version is created. Rather, the folder now includes file data 616 instead. Therefore, the link management engine 130 creates a link from the fife entry 606c to the file data 616.

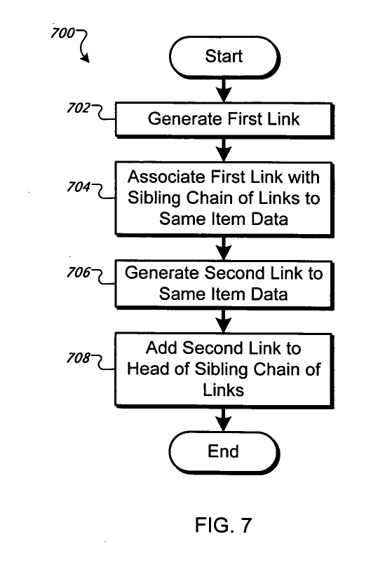

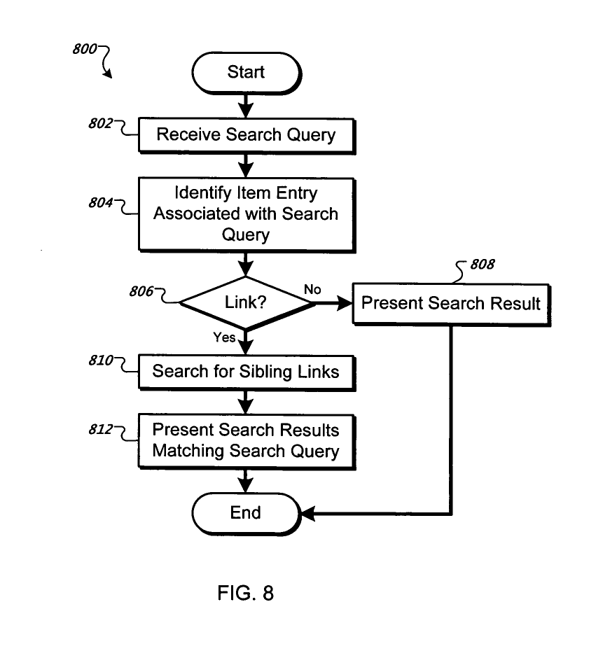

FIGS. 7 and 8 are flow charts of examples of processes 700 and 800 that involve link management and use. The processes 700 and 800 can be performed in the systems 100 or 200. For clarity of presentation, the description that follows uses the systems 100 and 200 as examples in describing individual steps. However, another system, or combination of systems, can be used to perform some or all of the processes 700 and 800.

FIG. 7 is a flow chart of an example of a process 700 for associating links with a chain of links. Process 700 begins with generating (702) a first link to item data. For example, when the preference management engine 214 specifies that links are to be used, the link management engine 130 can generate the link 207 from the item entry 242c to the item data 240c.

Process 700 associates (704) the first link with a sibling chain of links to the same item data, if there is one. For example, upon creation of the Version B backup (FIG. 4), the link management engine 130 associates the link 207 with any other item entry/entries also linking to the item data 240c. The associated links to the item data 240c form a sibling chain of links. In some implementations, the storage system that stores the items is a hierarchical file system including a catalog. Item entry identifiers and sibling chains of links are stored in the catalog. If there is no sibling chain of links for the item data in step 704, one is created.

Process 700 generates (706) a second link to the same item data. For example, upon creation of the Version C backup (FIG. 4), the link management engine 130 generates the link 209 from the item entry 244c to the item data 240c.

Process 700 adds (708) the second link to the sibling chain of links. For example, the link management engine 130 adds the link 209 and/or the item entry 244c to the head of a chain of links that refer to the item data 240c.

Some or all steps of the process 700 can be repeated as appropriate. For example, the steps 706 and 708 can be repeated for any and all new links to the same item data that are added.

FIG. 8 is a flow chart of an example of a process 800 for using a chain of links in performing a search. Process 800 begins with receiving (802) a search query. For example, a user can input a search query for a particular song that can be accessed using the iTunes application that in FIG. 5 is shown within the time machine interface 500.

Process 800 identifies (804) at least one item entry associated with the search query. For example, the item entry 604a (FIG. 6) can be identified as corresponding to the sought song. The item entry 604a leads to the file data 610 as was described above.

If the process determines in step 806 that the item is not a link to the item data, then process 800 presents (808) the search result and thereafter ends. For example, the process can determine that the item entry 604a directly refers to the file data 610 without using a link. In such an example, the identified item entry 604a would be presented to the user in step 808.

Otherwise, if it is determined in step 806 that the entry is a link to item data, then process 800 searches (810) for sibling links. For example, after identifying the item entry 242c in the search, it can be determined that this entry is a link to the item 240c. In such a situation, the link management engine 130 can search the catalog for the sibling chain of links associated with the item 240c. If any of the sibling links are responsive to the search performed in step 804, it is expected that they will be found in the performance of this step, and that this fact will be recognized in the search for sibling links (step 810). However, as was mentioned with reference to the item name 402 (FIG. 3), item entries linking to the same item can have different names. Thus, if the search (step 804) targets the entry names, it can happen that the search finds some but not all of the sibling links. In such situations, the not-yet-identified sibling link(s) can be found in the step 810. Identifying the missing sibling link(s) can provide the user with a more complete set of search results, to name just one advantage.

Process 800 presents (812) search results matching the search query. For example, the link management engine 130 in step 812 retrieves the item entry 244c using the sibling chain of links, in addition to the entry 242c that was found in step 804. A user interface can then present the item entries 244c and 242c, each of which can be used to access the item 240c.

It was mentioned above that some sibling links can be located in protected areas while others can be unprotected. The search in step 810, then, can lead to the identification of one or more unprotected sibling links that the user can activate to access the sought data item. In other words, when the step 804 identifies only a protected link to an item, the step 810 can determine whether the user is nevertheless authorized to view the item.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it could comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
generating a first backup, the first backup including a first hierarchical file system, where entries in the first hierarchal file system reference corresponding source data of the first backup; and
generating a second backup, the second backup including a second hierarchical file system, where the second hierarchical file system includes one or more links referencing source data of the first backup.

2. The method of claim 1, where the one or more links includes a link from a folder in the second hierarchical file system to data associated with the folder in the source data of the first backup.

3. The method of claim 1, where the one or more links are hard links.

4. The method of claim 1, where the first backup is generated prior to the second backup.

5. The method of claim 1, further comprising:
preventing the addition of new links to the first hierarchical file system after it has been created.

6. The method of claim 5, where the preventing includes flagging the first hierarchical file system as not accepting any new links.

7. The method of claim 1, where generating the second backup comprises generating the second hierarchical file system including:
determining whether particular source data from the second backup is unchanged from source data of the first backup; and
for the unchanged source data, generating one or more links in the second hierarchical file system referencing the unchanged source data in the first backup.

8. The method of claim 7, where generating links in the second hierarchical file system requires that the second hierarchical file system is not flagged as not accepting links.

9. The method of claim 1, where the first hierarchical file system has a structure that includes a plurality of entries, each entry including one or more additional entries.

10. The method of claim 9, where one or more of the entries are files.

11. A method comprising:
receiving a search for an item, the search including one or more parameters;
identifying a matching entry in the file system;
if the matching entry is a link,
identifying a chain of sibling links including the matching entry; and
presenting the entries associated with the sibling links.

12. The method of claim 11, where receiving a search for an item further comprises:
designating one or more search parameters associated with the search for an item; and
presenting only the entries matching the designated search parameters.

13. The method of claim 11, where one of the one or more search parameters is a time range associated with the search item.

14. The method of claim 11, further comprising:
determining if the matching entry is a link, including:
searching for the matching entry in a file system catalog; and
identifying whether the matching entry is part of a chain of sibling entries.

15. The method of claim 11, where the links are hard links.

16. The method of claim 11, there the link entry is a folder of a hierarchical file system.

17. A method comprising:
generating a second file system entry in a file system hierarchy, the second file system entry having a reference to source data already referenced by a first file system entry; and
associated the second file system entry with the first file system entry to form a sibling chain of links.

18. The method of claim 17, further comprising:
receiving subsequent file system entries, each file system entry referencing source data referenced by the first file system entry; and
adding each subsequent file system entry to the sibling chain of links.

19. The method of claim 18, further comprising:
receiving a search for an item associated with a link;
identifying each link in the sibling chain of links; and
determining one or more matching entries associated with the links of the sibling chain of links to present to a user.

20. The method of claim 19, where the determining includes comparing the matching entries with one or more parameters associated with the received search.

21. A method comprising:
generating a first backup, the first backup including a first hierarchical file system, where entries in the first hierarchical file system reference corresponding source data of the first backup;
generating a second backup, the second backup including a second hierarchical file system, where the second hierarchical file system includes one or more link entries referencing source data of the first backup;
receiving a search query associated with particular source data;
search for entries in the first and second backups referencing the source data associated with the search query; and
presenting search results including an entry from the first file hierarchical system and at least one link entry from the second hierarchical file system.

22. A data structure, comprising:
a hierarchical file system having a plurality of entries, the entries having a reference to particular source data, where an entry in the plurality of entries is a first folder entry, the first folder entry having a one or more child entries, and where an entry is a second folder entry, the second folder entry being a link referencing identical source data referenced by the first folder entry.

23. A method comprising:
initiating a backup;
identifying data to be included in the backup;
locating a previous backup;
comparing data of the previous backup with the data to be included in the backup to identify new data to be stored and old data that is unchanged from the previous backup; and
storing the new data and a plurality of links to the old data.

24. The method of claim 23, where the previous backup is an immediately preceding backup.

25. The method of claim 23, where comparing data includes identifying data present in the data to be included in the backup that is not present in the data of the previous backup.
